(19) United States
(12) Patent Application Publication
(10) Pub. No.: US 2003/0023857 A1
(43) Pub. Date: Jan. 30, 2003

(54) Malware infection suppression

(76) Inventors: Alexander James Hinchliffe, Milton Keynes (GB); Fraser Peter Howard, Chipping Norton (GB); Andrew Kemp, Oxford (GB); Bobby Rai, Kettering (GB)

Correspondence Address: NIXON & VANDERHYE P.C., 8th Floor, 1100 North Glebe Road, Arlington, VA, 22201-4714, US

(21) Appl. No.: 09/912,390

(22) Filed: Jul. 26, 2001

(51) Int. Cl. G06F 11/30

(52) U.S. Cl. 713/188

(57) ABSTRACT

A malware protection mechanism is described whereby upon detection of an item of malware or malware like behaviour, I/O devices (18, 20, 22) of a computer (4, 6, 8, 10) may be disabled in order to resist propagation of the malware or infection by the malware. Alternatively, a System Administrator may manually trigger the disablement of the I/O devices as a pre-emptive precaution against infection.

### BACKGROUND OF THE INVENTION

1. Field of the Invention

This invention relates to the field of data processing systems. More particularly, this invention relates to suppression of malware, such as computer viruses and unwanted e-mails, within computer systems

2. Description of the Prior Art

The threat from malware, such as computer viruses, Trojans, worms and unwanted e-mails, is increasing. The consequences of malware infection can be severe with potential loss of data and system downtime. Furthermore, the mechanisms by which malware can spread are becoming more rapid, e.g. internet connections are increasingly common and e-mail propagated viruses have recently led to a number of rapidly spreading and harmful malware outbreaks. Measures which can reduce the problems associated with malware are strongly advantageous.

### SUMMARY OF THE INVENTION

Viewed from one aspect the present invention provides a computer program product for controlling a computer, said computer program product comprising:

malware infection detecting logic operable to detect a malware infection of at least one computer; and

device disabling logic operable upon detection of said malware infection to disable operation of one or more data I/O devices of said at least one computer.

The invention recognises that the spreading of malware can be suppressed when malware infection has occurred by the disabling of I/O devices associated with the infected computer. In particular, in order to propagate itself between computers an item of malware will frequently require the use of an I/O device, such as a floppy disk drive, a removable media drive, a compact disk drive or a network interface card. Disabling these devices inhibits the ability of the malware to propagate itself and so reduces the consequences of malware infection.

The disabling of I/O devices may be triggered upon positive identification of a malware infection or more cautiously upon detection of behaviour indicative of malware detection. A more cautious approach is generally better able to deal with newly released malware threats as these may not be able to be positively identified s until the malware scanning system has been updated to include tests targeted at those new items of malware. Malware like behaviour could take a variety of forms, but examples would be the sending or receipt of a large number of e-mails bearing the same subject line or having a common attachment.

The malware suppression mechanisms mentioned above may be applied solely to the malware infected computer, or if a more cautious approach is being taken, to further computers even if they are not yet infected. Clearly there is a balance between the disruption caused by disabling the I/O devices of the computers and the disruption caused by potential malware infection.

A complementary aspect of the invention provides a computer program product for controlling a computer, said computer program product comprising:

device disabling logic operable upon receipt by a computer of a command indicative of malware infection precautions being taken to disable operation of one or more data I/O devices of said computer.

It may be that a central computer is responsible for identifying a malware infection or a malware infection is detected by a different client computer, but it is desirable that further computers are able to respond to appropriate commands to disable their I/O devices in order to resist malware infection and propagation.

A further aspect of the invention provides a computer program product for controlling a computer, said computer program product comprising:

user input logic operable to receive a user input indicative of activating precautions against a malware infection; and

device disabling logic operable upon receipt of said user input to disable operation of one or more data I/O devices of said at least one computer.

This aspect of the invention allows the I/O disabling action to be taken in response to a manual user input thereby allowing pre-emptive action to be taken to resist malware infection and propagation even if the malware infection has not yet occurred. As an example, a System Administrator may become aware of a rapidly spreading malware threat through media reports or the like and accordingly decide to disable I/O devices as a precaution against potential infection.

Further aspects of the invention provide methods of protecting against malware infection and an apparatus for protecting against malware infection in accordance with the above described techniques.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a computer network of a type that may be vulnerable to malware infection;

FIG. 2 illustrates various software components within a computer;

FIG. 3 is a flow diagram illustrating processing that may be performed by a computer responsible for coordinating malware protection;

FIG. 4 is a flow diagram illustrating the response of a client computer to a disable command;

FIG. 5 is a diagram illustrating the processes by which malware precautions may be triggered semi-automatically; and

FIG. 6 is a schematic diagram illustrating a general purpose computer of a type that may be used to implement the above described techniques.

### DESCRIPTION OF THE PREFERRED EMBODIMENTS

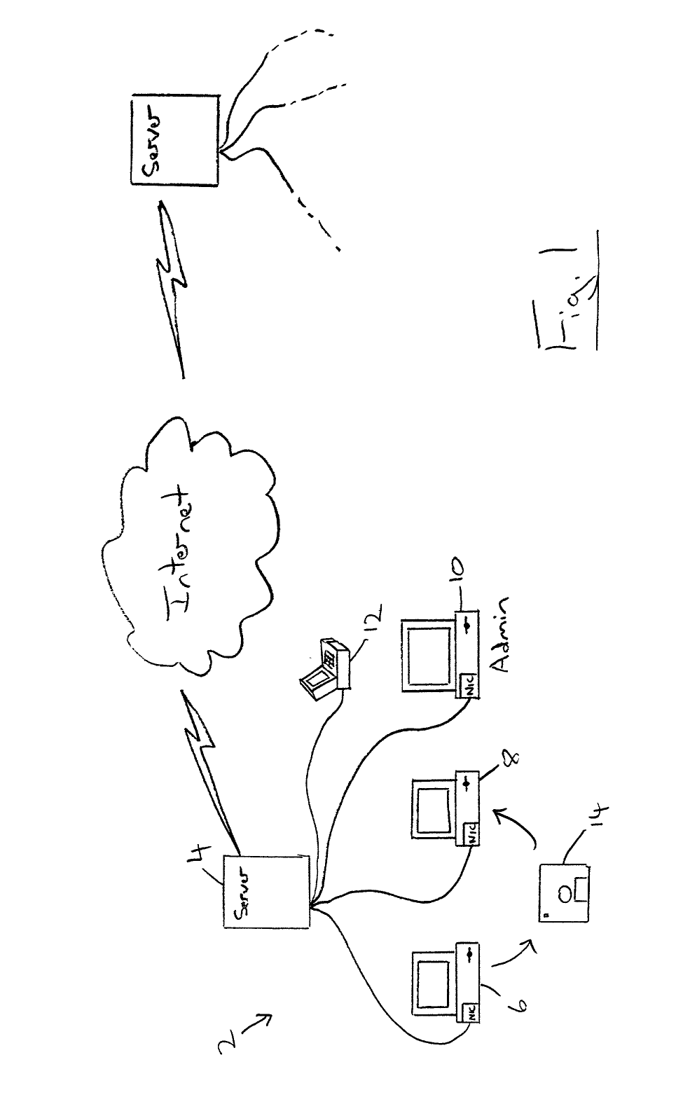

FIG. 1 illustrates a computer network 2 comprising a server 4 and a plurality of client computers 6, 8, 10. In addition a laptop computer 12 may occasionally be connected to the network 2.

The network 2 is vulnerable to malware infection and propagation due to computer viruses and the like being received from removable media 14, such as a floppy disk drive, a zip drive, a Jazz drive, a solid state storage device etc. These removable media may also be passed between users and accordingly propagate infection between computers. A further mechanism by which a malware infection can propagate within the network 2 is via the network interface cards, NICs, associated with each of the client computers 6, 8, 10. File sharing or files stored on the server 4 may propagate the infection, or alternatively e-mails with infected files may be exchanged between network connected computers.

The computer network 2 is connected via the internet to other computer systems and may receive malware infections via its internet connection. The laptop computer 12 may be infected at home, or at another place, and then carry the infection back to the network 2 when it is connected to that network 2 at a later time.

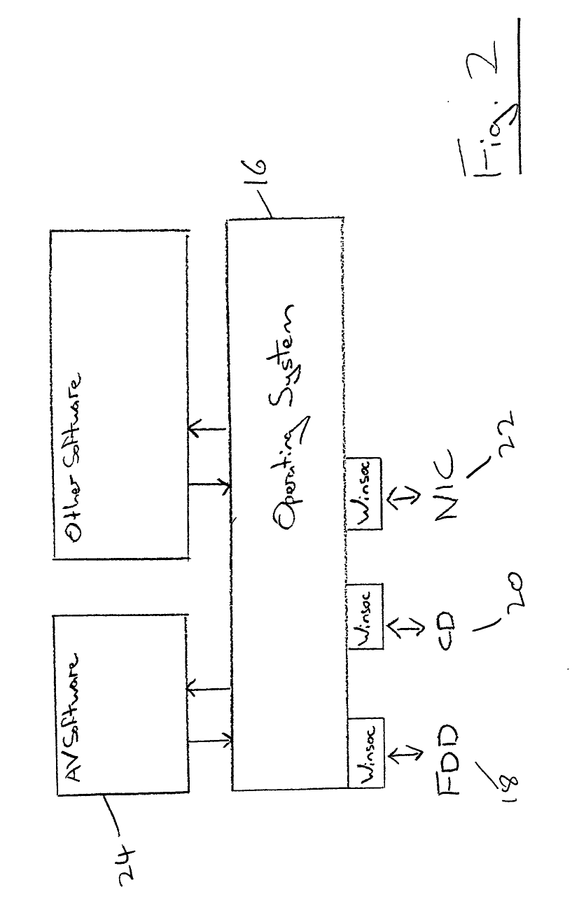

FIG. 2 schematically illustrates a number of software components that are typically present within a general purpose computer. An operating system 16 is provided to handle the interface with various physical I/O devices such as a floppy disk drive 18, a compact disk drive 20 and a network interface card 22. In the Windows™ operating system (produced by Microsoft Corporation) a winsoc interface is provided for connecting each of these physical I/O devices 18, 20, 22 to the operating system 16.

Application software need not be directly aware of the configuration and control of the underlying I/O devices 18, 20, 22 as this functionality is carried out by the operating system 16. The application software instead makes API (application program interface) calls to the operating system 16 to instruct the operating system 16 to perform the desired operation. Anti-virus software 24 can operate as such application software and use the operating system 16 to control the input/output devices 18, 20, 22 on its behalf. API calls are provided by the operating system 16 that enable an application program, such as the anti-virus software 24 to disable and re-enable I/O devices 18, 20, 22. These API calls may be used to disable the I/O devices as required in accordance with the techniques described below.

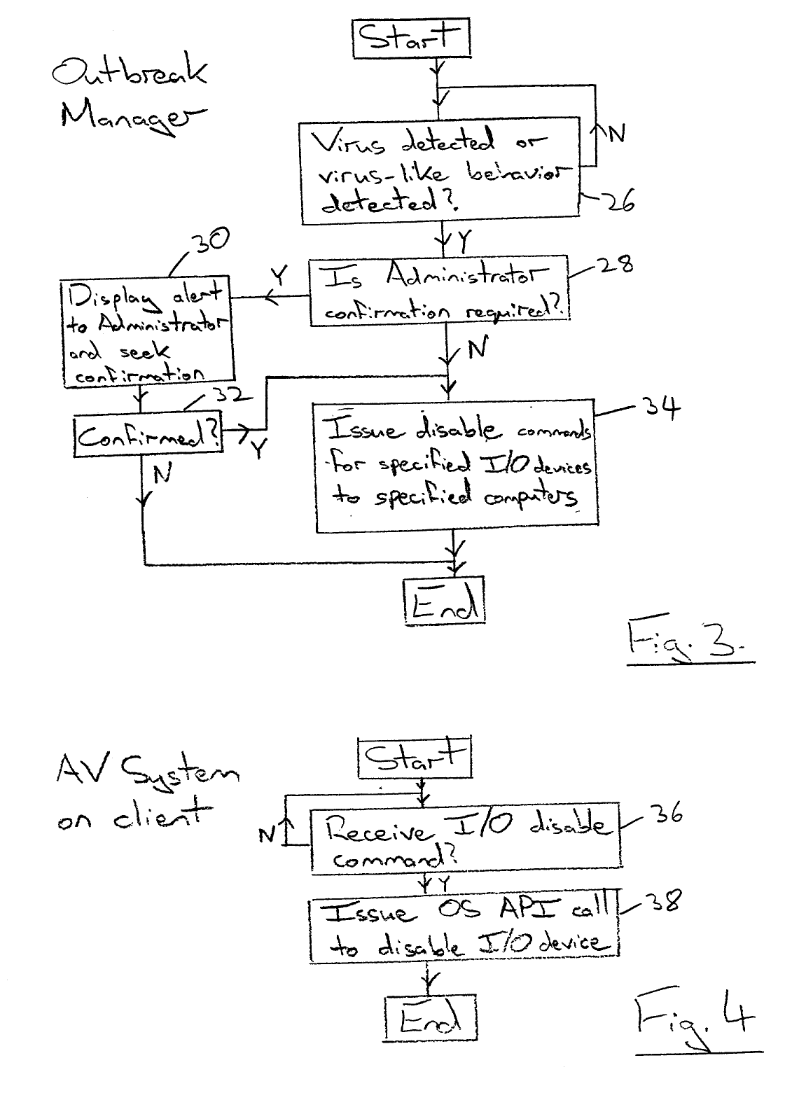

FIG. 3 is a flow diagram illustrating the operation of a computer program that serves to co-ordinate and manage at least part of the malware protection of a computer system. An example of such a computer program is Outbreak Manager produced by Network Associates, Inc. This type of coordinating computer program can be modified in accordance with the above described techniques to command disabling of I/O devices of specified computers.

At step 26 the system waits until a virus (an item of malware) is detected or virus-like behaviour is detected. Rapid changes in network traffic or the receipt of multiple e-mails containing an identical attachment would be behaviours that could be regarded as virus-like. A virus may also be positively detected via on-access or on-demand scanning mechanisms.

When a virus or virus-like behaviour is detected referencing predetermined rules, processing proceeds to step 28. Depending upon user configured parameters, confirmation of I/O device disablement may be required before this is carried out. If such confirmation is required, then processing proceeds to step 30 where an alert concerning the detected behaviour is displayed to an administrator and their confirmation that I/O device disablement should proceed is sought. If this confirmation is given, then step 32 directs processing to step 34 at which the coordinating computer issues I/O device disabling commands to one or more attached computers for which the coordinating computer is responsible for managing malware protection. If the disablement is not confirmed at step 32, then the processing terminates. Alternatively, if confirmation was not required at step 28, then processing proceeds directly to step 34.

Depending upon user set parameters the response to the detected behaviour may be to disable the I/O devices of only the computer upon which the virus has been detected. The number/type of I/O devices disabled may also be configured. Disablement of I/O devices may extend beyond the computer upon which the infection was detected. In accordance with the principals of operation of Outbreak Manager an escalating series of responses may be predefined and followed automatically, semi-automatically or manually as a malware outbreak develops.

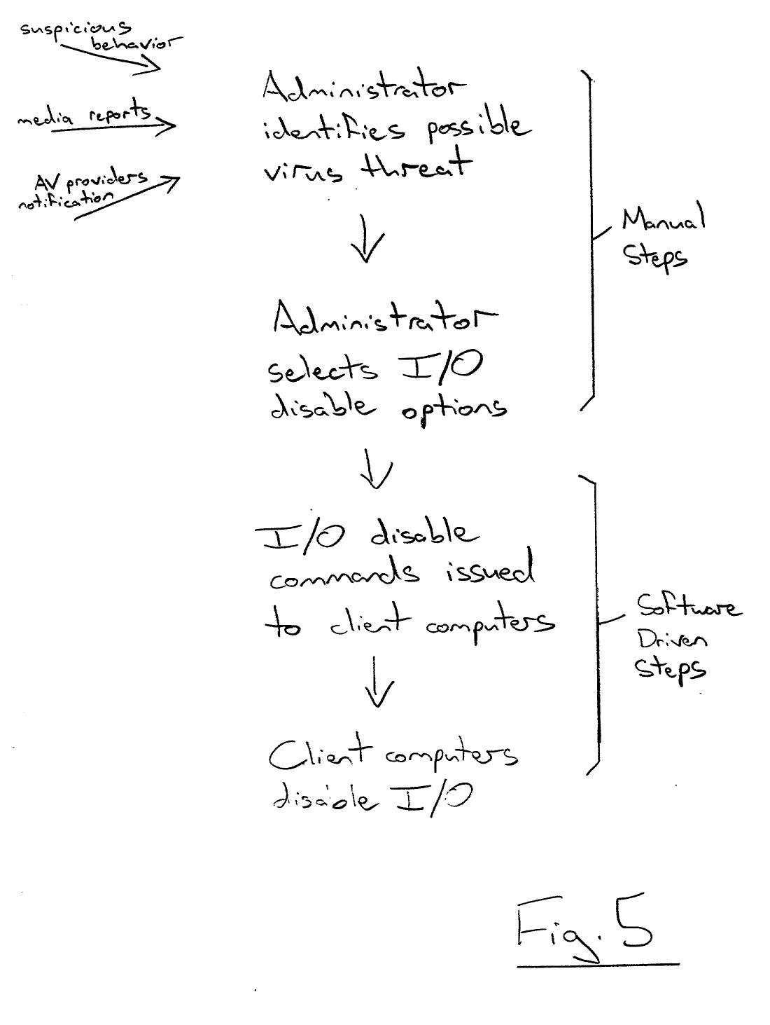

FIG. 4 is a flow diagram schematically illustrating the response of a client computer to commands received from the outbreak manager computer. At step 36 the client computer waits to receive an I/O disablement command. When an I/O disablement command is received, then processing proceeds to step 38 and the anti-virus software 24 issues appropriate API calls to the operating system 16 to disable the selected I/O devices 18, 20, 22.

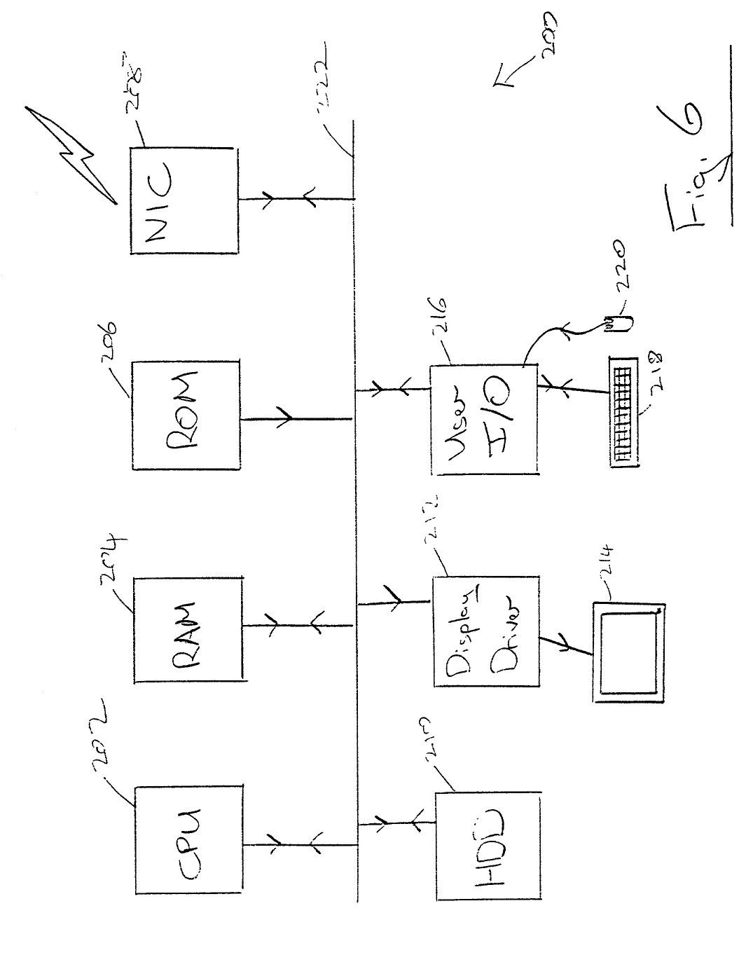

FIG. 5 illustrates another way in which the above described technique may be used. In this case a system administrator becomes aware of a possible virus threat through observing suspicious behaviour of their system, through media reports or through notifications from an anti-virus provider, as well as by other means. If the administrator considers this threat credible, then they may choose to manually trigger disablement of I/O devices, either partially or wholly, upon one or more computers for which they are responsible. This action may be taken as a pre-emptive precaution against infection. An example would be that an administrator may wish to reduce the likelihood of infection at the cost of some inconvenience to their users through the non-availability of their I/O devices until they had confirmed that the potential malware threat was not significant or they had put appropriate other precautions in place, such as downloading the latest virus definition data including a driver for the new malware threat.

When the administrator has selected the I/O device disable option, then the software will automatically trigger the appropriate I/O disable commands to be issued to the client computers specified and those client computers will respond by disabling their I/O devices.

FIG. 6 schematically illustrates a general purpose computer 200 of the type that may be used to implement the above described techniques. The general purpose computer 200 includes a central processing unit 202, a random access memory 204, a read only memory 206, a network interface card 208, a hard disk drive 210, a display driver 212 and monitor 214 and a user input/output circuit 216 with a keyboard 218 and mouse 220 all connected via a common bus 222. In operation the central processing unit 202 will execute computer program instructions that may be stored in one or more of the random access memory 204, the read only memory 206 and the hard disk drive 210 or dynamically downloaded via the network interface card 208. The results of the processing performed may be displayed to a user via the display driver 212 and the monitor 214. User inputs for controlling the operation of the general purpose computer 200 may be received via the user input output circuit 216 from the keyboard 218 or the mouse 220. It will be appreciated that the computer program could be written in a variety of different computer languages. The computer program may be stored and distributed on a recording medium or dynamically downloaded to the general purpose computer 200. When operating under control of an appropriate computer program, the general purpose computer 200 can perform the above described techniques and can be considered to form an apparatus for performing the above described technique. The architecture of the general purpose computer 200 could vary considerably and FIG. 6 is only one example.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A computer program product for controlling a computer, said computer program product comprising:
malware infection detecting logic operable to detect a malware infection of at least one computer; and
device disabling logic operable upon detection of said malware infection to disable operation of one or more data I/O devices of said at least one computer.

2. A computer program product as claimed in claim 1, wherein said malware infection detection logic detects a malware infection by one or more of:
positively identifying an item of malware upon said at least one computer; and
identifying behaviour of said at least one computer indicative of malware infection.

3. A computer program product as claimed in claim 1, wherein said one or more data I/O devices include one or more of:
a floppy disk drive;
a compact disk drive;
a removable media drive; and
a network interface card.

4. A computer program product as claimed in claim 1, wherein said device disabling logic is operable upon detection of malware infection to disable at least one data I/O device of at least one further computer.

5. A computer program product as claimed in claim 1, wherein said device disabling logic is operable to require user confirmation prior to disabling said one or more data I/O devices.

6. A computer program product as claimed in claim 1, wherein said device disabling logic is operable to disable said one or more data I/O devices using an API call to an operating system of said at least one computer.

7. A computer program product for controlling a computer, said computer program product comprising:
device disabling logic operable upon receipt by a computer of a command indicative of malware infection precautions being taken to disable operation of one or more data I/O devices of said computer.

8. A computer program product as claimed in claim 7, wherein said one or more data I/O devices include one or more of:
a floppy disk drive;
a compact disk drive;
a removable media drive; and
a network interface card.

9. A computer program product as claimed in claim 7, wherein said device disabling logic is operable to disable said one or more data I/O devices using an API call to an operating system of said at least one computer.

10. A computer program product for controlling a computer, said computer program product comprising:
user input logic operable to receive a user input indicative of activating precautions against a malware infection; and
device disabling logic operable upon receipt of said user input to disable operation of one or more data I/O devices of said at least one computer.

11. A computer program product as claimed in claim 10, wherein said one or more data I/O devices include one or more of:
a floppy disk drive;
a compact disk drive;
a removable media drive; and
a network interface card.

12. A computer program product as claimed in claim 10, wherein said device disabling logic is operable upon detection of malware infection to disable at least one data I/O device of at least one further computer.

13. A computer program product as claimed in claim 10, wherein said device disabling logic is operable to disable said one or more data I/O devices using an API call to an operating system of said at least one computer.

14. A method of protecting against malware infection, said method comprising the steps of:
detecting a malware infection of at least one computer; and
upon detection of said malware infection disabling operation of one or more data I/O devices of said at least one computer.

15. A method as claimed in claim 14, wherein detection of a malware infection is by one or more of:
positively identifying an item of malware upon said at least one computer; and
identifying behaviour of said at least one computer indicative of malware infection.

16. A method as claimed in claim 14, wherein said one or more data I/O devices include one or more of:
a floppy disk drive;
a compact disk drive;
a removable media drive; and
a network interface card.

17. A method as claimed in claim 14, wherein upon detection of malware infection at least one data I/O device of at least one further computer is disabled.

18. A method as claimed in claim 14, wherein user confirmation is required prior to disabling said one or more data I/O devices.

19. A method as claimed in claim 14, wherein disabling said one or more data I/O devices uses an API call to an operating system of said at least one computer.

20. A method of protecting against malware infection, said method comprising the steps of:
upon receipt by a computer of a command indicative of malware infection precautions being taken disabling operation of one or more data I/O devices of said computer.

21. A method as claimed in claim 20, wherein said one or more data I/O devices include one or more of:
a floppy disk drive;
a compact disk drive;
a removable media drive; and
a network interface card.

22. A method as claimed in claim 20, wherein disabling said one or more data I/O devices uses an API call to an operating system of said at least one computer.

23. A method of protecting against malware infection, said method comprising the steps of:
receiving a user input indicative of activating precautions against a malware infection; and
upon receipt of said user input disabling operation of one or more data I/O devices of said at least one computer.

24. A method as claimed in claim 23, wherein said one or more data I/O devices include one or more of:
a floppy disk drive;
a compact disk drive;
a removable media drive; and
a network interface card.

25. A method as claimed in claim 23, wherein upon detection of malware infection disabling at least one data I/O device of at least one further computer.

26. A method as claimed in claim 23, wherein disabling said one or more data I/O devices uses an API call to an operating system of said at least one computer.

27. Apparatus for protecting against malware infection, said apparatus comprising:
a malware infection detector operable to detect a malware infection of at least one computer; and
a device disabling unit operable upon detection of said malware infection to disable operation of one or more data I/O devices of said at least one computer.

28. Apparatus as claimed in claim 27, wherein said malware infection detector detects a malware infection by one or more of:
positively identifying an item of malware upon said at least one computer; and
identifying behaviour of said at least one computer indicative of malware infection.

29. Apparatus as claimed in claim 27, wherein said one or more data I/O devices include one or more of:
a floppy disk drive;
a compact disk drive;
a removable media drive; and
a network interface card.

30. Apparatus as claimed in claim 27, wherein said device disabling unit is operable upon detection of malware infection to disable at least one data I/O device of at least one further computer.

31. Apparatus as claimed in claim 27, wherein said device disabling unit is operable to require user confirmation prior to disabling said one or more data I/O devices.

32. Apparatus as claimed in claim 27, wherein said device disabling unit is operable to disable said one or more data I/O devices using an API call to an operating system of said at least one computer.

33. Apparatus for protecting against malware infection, said apparatus comprising:
a device disabling unit operable upon receipt by a computer of a command indicative of malware infection precautions being taken to disable operation of one or more data I/O devices of said computer.

34. Apparatus as claimed in claim 33, wherein said one or more data I/O devices include one or more of:
a floppy disk drive;
a compact disk drive;
a removable media drive; and
a network interface card.

35. Apparatus as claimed in claim 33, wherein said device disabling unit is operable to disable said one or more data I/O devices using an API call to an operating system of said at least one computer.

36. Apparatus for protecting against malware infection, said apparatus comprising:
a user input unit operable to receive a user input indicative of activating precautions against a malware infection; and
a device disabling unit operable upon receipt of said user input to disable operation of one or more data I/O devices of said at least one computer.

37. Apparatus as claimed in claim 36, wherein said one or more data I/O devices include one or more of:
a floppy disk drive;
a compact disk drive;
a removable media drive; and
a network interface card.

38. Apparatus as claimed in claim 36, wherein said device disabling unit is operable upon detection of malware infection to disable at least one data I/O device of at least one further computer.

39. Apparatus as claimed in claim 36, wherein said device disabling unit is operable to disable said one or more data I/O devices using an API call to an operating system of said at least one computer.
